(19) United States
(12) Patent Application Publication
(10) Pub. No.: US 2016/0067873 A1
(43) Pub. Date: Mar. 10, 2016

(54) Systems and Methods for Cutting Guides with Interchangeable Handles

(71) Applicants: Teri M. Dickinson, Homer, IL (US); Curtis D. Dickinson, Homer, IL (US)

(72) Inventors: Teri M. Dickinson, Homer, IL (US); Curtis D. Dickinson, Homer, IL (US)

(21) Appl. No.: 14/482,100

(22) Filed: Sep. 10, 2014

(51) Int. Cl. B26B 29/06; D06H 7/00

(52) U.S. Cl. CPC B26B 29/06; D06H 7/00

(57) ABSTRACT

Systems and methods for fabric cutting guides are provided. The cutting guide system includes interchangeable cutting guides and interchangeable handles. The cutting guides include a base having a fabric engagement structure on the bottom. The fabric engagement structure includes a seam engagement surface to engage with a seam of a fabric piece in order to position the fabric piece as desired. Once the fabric piece is positioned, at least a portion of the perimeter of the base may be used as a cutting guide so that a user may cut along the side of the base with a blade in order to produce fabric shapes that are highly uniform. The base also includes a socket so that the interchangeable handle may be interchanged between cutting guides. Additionally, the interchangeable handle has a height sufficient to remove a user's have from the proximity of the cutting guide when in use.

### BACKGROUND OF THE INVENTION

The present invention generally relates to cutting guides. More particularly, the present invention relates to a guide for cutting fabric for use in quilting.

In practice, it is common when quilting that a person constructing a quilt may desire to use several pieces of fabric that are composed of one or more other pieces of fabric that have been sewn together. However, in order for the quilt to be regular, the several pieces of fabric composed of other pieces of fabric sewn together must be highly uniform in size.

Unfortunately, making highly-regularly-shaped fabric pieces composed of two or more pieces of fabric stitched together is difficult for many quilters. However, many quilters employ a mechanical sewing machine that is capable of sewing straight seams. Consequently, the typical practice is to sew two or more pieces of fabric together along an edge and then attempt to cut the sewn pieces of fabric into a desired shape. However, this cutting is often performed by the quilters by hand and thus may lead to undesirable irregularity in the shapes of the resulting fabric pieces.

### BRIEF SUMMARY OF THE INVENTION

One or more of the embodiments of the present invention provide interchangeable cutting guides and interchangeable handles. The cutting guides include a base having a fabric engagement structure on the bottom. The fabric engagement structure includes a seam engagement surface that engages with the seam of a fabric piece in order to position the fabric piece as desired. Once the fabric piece is positioned, at least a portion of the perimeter of the base may be used as a cutting guide so that a user may cut along the side of the base using a blade to produce fabric shapes that are highly uniform. The bases of the cutting guides also include a socket so that the interchangeable handle may be interchanged between cutting guides.

### BRIEF DESCRIPTION OF THE DRAWINGS

FIG. 1 illustrates a top perspective view of a half-square positionable cutting guide according to an embodiment of the present invention.

FIG. 2 illustrates a bottom perspective view of the “half-square” cutting guide of FIG. 1.

FIG. 3 illustrates a top view of the base of the half-square cutting guide of FIG. 2.

FIG. 4 illustrates a bottom view of the base of the half-square cutting guide of FIG. 2.

FIG. 5 illustrates a side view of the base of the half-square cutting guide of FIG. 1.

FIG. 6 illustrates an alternative cutting guide for cutting a “quarter-square” shape.

FIG. 7 illustrates an alternative cutting guide for cutting a “flying geese” shape.

FIG. 8 illustrates an interchangeable handle that may be employed with any of the cutting guides discussed herein.

FIG. 9 illustrates a diamond-shape half-square cutting guide.

FIG. 10 illustrates an alternative handle grip element having an “S” shape.

FIG. 11 illustrates an alternative handle grip element having finger shaping.

FIG. 12 illustrates an alternative handle grip element having a “T” shape.

FIG. 13 illustrates an alternative handle grip element having an “U” shape with two connection points.

### DETAILED DESCRIPTION OF THE INVENTION

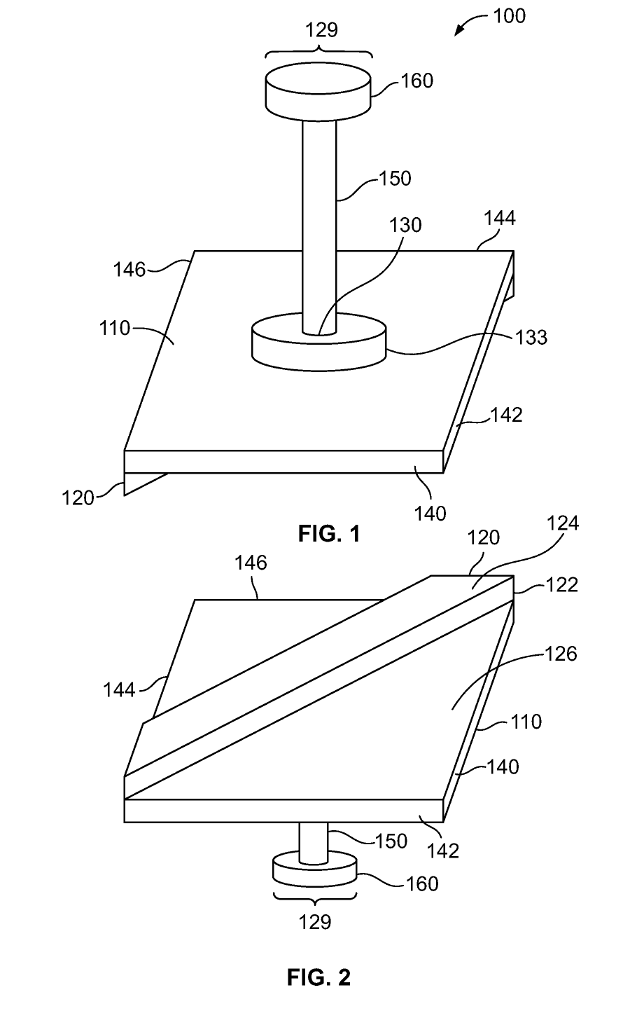

FIG. 1 illustrates a top perspective view of a “half-square” positionable cutting guide 100 according to an embodiment of the present invention. The cutting guide 100 includes an interchangeable base 110 and an interchangeable handle 129. The base plate 110 includes a fabric engagement structure 120, a handle socket 130, and cutting guide edges 140-146. The handle 129 includes a handle shaft 150 and a handle grip element 160. It is noted that the embodiment of the cutting guide shown in FIGS. 1-5 may be referred to as a “half-square” cutting guide because it assists in making an accurate “half-square” style cut.

As shown in FIG. 1, the fabric engagement structure 120 is attached to or formed as part of the base 110. The handle socket 130 is threaded, as is the portion of the handle shaft 150 opposite the handle grip element 160. To attach the handle 129 to the base 110, the threaded portion of the handle 129 is threaded into the threads present in the handle socket 130.

FIG. 2 illustrates a bottom perspective view of the cutting guide 100 of FIG. 1. FIG. 2 shows the base 110, handle 129, handle shaft 150, handle grip element 160, and cutting edges 140-146. Additionally, the fabric engagement structure 120 may be better seen. As shown in FIG. 2, the fabric engagement structure 120 includes a seam engagement surface 122, a fabric holding surface 124, and a fabric height relief region 126.

As mentioned above, it is common when quilting that a person constructing a quilt may desire to use several square-shaped pieces of fabric that are

composed of two triangular sections of fabric sewn together. However, in order for the quilt to be regular, the several square-shaped pieces must be highly uniform in size. Unfortunately, making highly-regularly-shaped fabric squares composed of two pieces of fabric stitched together is difficult for many quilters. However, many quilters employ a mechanical sewing machine that is capable of sewing straight seams. Consequently, the typical practice is to sew two pieces of fabric together along an edge and then attempt to cut the sewn pieces of fabric into a square shape. However, this cutting is often performed by the quilters by hand and thus may lead to irregularity in the shapes of the resulting squares.

Conversely, as further described below, one or more embodiments of the present invention provide a cutting guide having a fabric engagement structure 120 that may be positioned proximal to and/or engaging with a seam between two fabrics. The cutting guide 100 also includes a plurality of cutting surfaces 140-146 so that once the fabric engagement structure 120 is engaged with the seam, a user may use the cutting surfaces as a cutting guide to correctly and regularly size squares of material produced using the cutting guide. For example, the user may advance a straight-edge or wheel-based cutting device along the cutting surfaces 140-146 while contacting the fabric engaged with the fabric engagement structure 120 in order to cut the fabric.

More specifically, the straight seam is preferably positioned proximally, in contact with, and/or engaging the seam engagement surface 122 of the fabric engagement structure 120. Additionally, when two pieces of fabric are sewn together, one side of the seam includes a seam allowance, which is formed of a tab of fabric. Further, when the sewn together two pieces of fabric are placed on a flat surface with the seam allowance side down, the seam allowance will fold or rotate to one side of the seam and be positioned under one of the pieces of fabric. Thus, the fabric under one side of the seam will be displaced upwards by the thickness of the seam allowance so that the surface described by the sewn together two pieces of fabric is higher on one side of the seam than the other.

In such a configuration, the fabric engagement structure 120 is positioned so that the fabric holding surface 124 is pressed downwardly against fabric on the lower side of the seam, the seam engagement surface 122 is positioned proximally to the seam, and the fabric on the higher side of the seam that is underlaid by the seam allowance “marries into” or fits into the fabric height relief region 126.

Once positioned, the cutting guide 100 may be highly stable for a several reasons. First, only a single layer of fabric is positioned between the fabric holding surface 124 and the firm, flat surface supporting the fabric. Additionally, the rise in the fabric profile or shape from one side of the seam to the other side of the seam due to the presence of the seam allowance forms a ridge, rise, and/or increase in fabric height that marries into or engages with the seam engagement surface to reduce lateral movement of the fabric relative to the cutting guide 100. Additionally, the presence of the fabric height relief region 126 provides for the additional fabric height on one side of the seam due to the presence of the seam allowance. Without the fabric height relief region, the lower surface of the cutting guide would be flat and would instead contact the thicker/taller fabric with the seam under the fabric. Unfortunately, pressing down on fabric underlaid by a seam is less stable and more prone to undesirable shifting than pressing down on a single layer of fabric supported by a firm support surface.

The seam engagement surface 122 extends downwardly from the bottom of the base 110, preferably vertically, but may be oriented at an angle, such as 45 degress, for example. Other angles may include about any angle in the range of 10 to 90 degrees including increments of 5 degrees within that range.

The fabric engagement structure 120 is preferably composed of a rigid material, such as a plastic or polymer. Alternatively, it may be composed of a deformable material such as rubber or neoprene or may be coated with rubber or neoprene. Additionally, the fabric engagement structure may also be formed as part of the base 110.

Additionally, although the fabric engagement structure 120 is shown in FIG. 2 as occupying a portion of half of a diagonal of the base, the fabric engagement structure 120 may occupy the entire base. Alternatively, the fabric engagement structure 120 may extend downwardly along the perimeter of the base or may include an additional downward structure at the corner of the base including the structure.

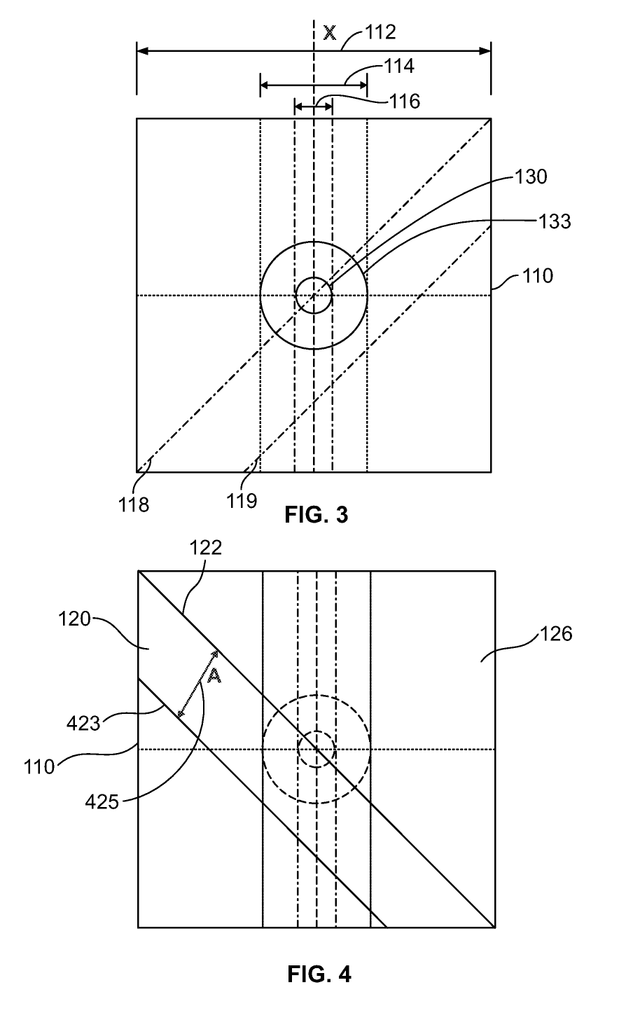

FIG. 3 illustrates a top view of the base 110 of the cutting guide 100 of FIG. 2. The base 110 includes the handle socket 130 and a handle attachment structure 133. The dimensions of several aspects of the base are also indicated including the base side width 112, the handle attachment structure width 114, and the handle socket width 116. Additionally, the position of the fabric engagement structure 120 on the other side of the base 110 is indicated by dotted lines 118-119.

In one or more embodiments, the base side width 112 may preferably be 3 inches, but may vary from about an inch and a half to about six and one half inches, with different embodiments being sized at about half inch increments at 2, 2.5, 3, 3.5, 4, 4.5, 5, 5.5, and 6 inches in length, although there are no upper or lower length limits. The length may also be in centimeters in which case various embodiments range from about 3 cm to about 20 cm in increments of about one cm.

The handle attachment structure width 114, may preferably be one inch, but may vary in length from the entire width of the base 110 to ⅛ of an inch. Alternatively, the handle attachment structure 133 may be formed as part of the top surface of the base 110 and not protrude from the base. In this case, the base 110 may merely be a flat plane with a socket for receiving the handle.

The handle socket width 116 may preferably be one half inch in length, but may be any length less than the base side width of the handle attachment structure width when the handle attachment structure is present as a maximal size, and any size sufficient to receive the handle as a minimum. For example, the handle socket width 116 may vary from one quarter of an inch to one inch in quarter inch increments.

As additional alternatives, the handle attachment structure 133 may alternatively be configured so that there is no handle socket 130 and instead the exterior of the handle attachment structure 133 is threaded and the handle is configured to thread onto the thread on the exterior of the handle attachment structure.

Alternatively, the handle may be attached to the base using a spring-biased locking system, such as a locking pin protruding from the shaft of the handle that may engage with a receiver on the base when the shaft of the handle is introduced into the handle socket. The locking pin may then be manually pressed to disengage the shaft of the handle from the base when desired.

FIG. 4 illustrates a bottom view of the base 110 of the cutting guide 100 of FIG. 2. The base 110 includes the fabric engagement structure 120, the seam engagement structure 122, the fabric height relief region 126, and the fabric engagement structure back edge 423. The fabric engagement structure width 425 is also indicated and represents the width between the seam engagement structure 122 and the fabric engagement structure back edge 423.

The fabric engagement structure width 425 may preferably be three-quarters of an inch, but may vary from any width greater than zero to occupying the entire half of the bottom of the base. In one embodiment, when the fabric engagement structure width 425 occupies substantially the entire half of the bottom of the base, the fabric engagement structure width 425 maybe about 0.707 times the length of a side of the base plate 110 or the length of one of the cutting guide edges 140-146. Expressed another way, where X is the length of one of the sides of the base plate 110, the length of the diagonal of the base plate 110 may be found as Z where:

X²+X²=Z²

This may be simplified to Z=1.414*X. Thus, one-half of the length of the diagonal of the base plate 110 is half of this number or 0.707*X, as mentioned above.

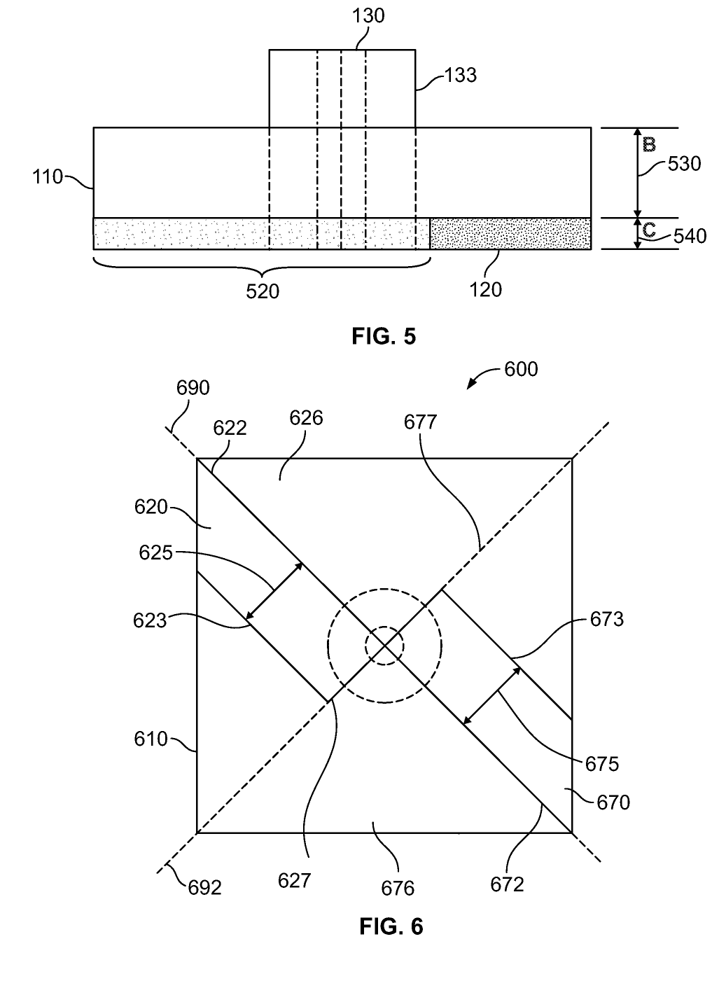

FIG. 5 illustrates a side view of the base 110 of the cutting guide 100 of FIG. 1. FIG. 5 shows the base 110, the handle attachment structure 133, the handle socket 130, the fabric engagement structure 120, and a shaded area 520 representing the area behind the fabric engagement structure back edge 423. Additionally, the base height 530 and fabric engagement structure height 540 are also shown.

The base height 530 may preferably be one quarter of an inch, but may range in size from anything greater than zero to one inch in quarter inch increments, although there is no upper limit on the base height 530.

Additionally, the fabric engagement structure height 540 may preferably be one eighth of an inch, but may range in size from anything greater than zero to one half of an inch in increments of one eighth of an inch, although there is no upper limit on the fabric engagement structure height 540.

It is noted that the embodiment of the cutting guide shown in FIGS. 1-5 may be referred to as a “half-square” cutting guide because it assists in making an accurate “half-square” style cut.

FIG. 6 illustrates an alternative cutting guide 600 for cutting a “quarter-square” shape. More specifically, FIG. 6 illustrates the bottom view of the base of the quarter-square cutting guide, similar to how FIG. 4 above illustrates the bottom view of the half-square cutting guide. The top view and side view of the quarter-square cutting guide, and the structures shown therein, are generally similar to those shown above for the half-square cutting guide in FIGS. 3 and 5.

As shown in FIG. 6, the quarter-square cutting guide 600 includes a base 610 having a first fabric engagement surface 620 and a second fabric engagement surface 670. The first and second fabric engagement surfaces are positioned along first diagonal line 690 and second diagonal line 692, which are shown for ease of understanding the positioning of the fabric engagement surfaces and do not represent physical elements of the base 610. Further, the first and second diagonal lines 690, 692 are preferably mutually perpendicular.

The quarter-square cutting guide 600 is used when four pieces of fabric have been sewn into an X-shape and are desired to be cut into a regular square size with the center of the X-shape at the center of the square.

The first fabric engagement surface 620 includes a first seam engagement structure 622, a first fabric height relief region 626, and a first fabric engagement structure back edge 623. The first fabric engagement structure width 625 is also indicated and represents the width between the first seam engagement structure 622 and the first fabric engagement structure back edge 623. The first center seam engagement structure 627 is also shown.

The second fabric engagement surface 670 includes a second seam engagement structure 672, a second fabric height relief region 676, and a second fabric engagement structure back edge 673. The second fabric engagement structure width 675 is also indicated and represents the width between the second seam engagement structure 672 and the second fabric engagement structure back edge 673. The second center seam engagement structure 677 is also shown.

As shown in FIG. 6, the first and second seam engagement structures 622, 672 are aligned along the first diagonal line 690 and the first and second center seam engagement structures 627, 677 are aligned along the second diagonal line 692.

In operation, a fabric piece including four pieces of fabric that have been sewn together in an X-shape is positioned so that the center of the X-shape is located at the center of the quarter-square cutting guide 600. In this position, a first seam of the fabric is proximal to or engaged with said first seam engagement structure 622, a second seam of the fabric is proximal to or engaged with said second seam engagement structure 672, a third seam of said fabric is proximal to or engaged with said first center seam engagement structure 627, and the fourth seam of said fabric is proximal to or engaged with said second center seam engagement structure 677.

The fabric engagement surfaces and seam engagement structures operate generally similarly to those discussed above with regard to the half-square cutting guide, except for accommodating the X-shaped seams of the fabric piece.

Additionally, the first and/or second fabric engagement structure widths 625, 675 may range in size from anything more than zero to triangular pieces occupying their respective quarters of the bottom side of the base 610. Alternatively, the first and/or second fabric engagement structure widths 625, 675 may preferably be about three-quarters of an inch, but may vary in about quarter-inch increments. Additionally, the first and second fabric engagement structure widths 625, 675 may be about 0.707 times the length of a side of the base.

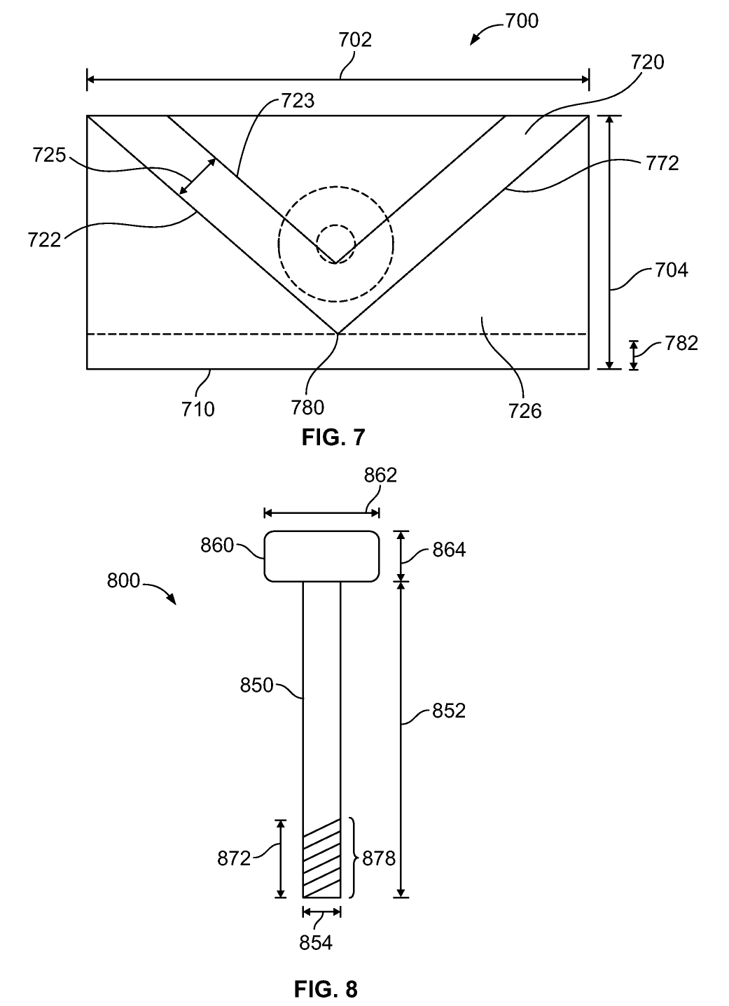

FIG. 7 illustrates an alternative cutting guide 700 for cutting a “flying geese” shape. More specifically, FIG. 7 illustrates the bottom view of the base 710 of the flying-geese cutting guide, similar to how FIG. 4 above illustrates the bottom view of the half-square cutting guide. Although the bottom view of the flying-geese cutting guide is quite different from the half-square and quarter-square described above, in one embodiment, the top view and side view of the quarter-square cutting guide, and the structures shown therein, are generally similar to those shown above for the half-square cutting guide in FIGS. 3 and 5, except the base of the flying-geese cutting guides is generally preferably rectangular.

As shown in FIG. 7, the flying-geese cutting guide 700 includes a base 710 having a fabric engagement surface 720. The base 710 includes a base first side length 702 and a base second side length 704. The fabric engagement surface 720 has a first seam engagement structure 722 and a second seam engagement structure 772 as well as a fabric engagement structure back edge 723 and fabric engagement structure width 725. Additionally, the fabric engagement structure 720 includes a fabric engagement tip 780 that is offset from the edge of the base 710 by the tip offset 782. The fabric height relief region 726 is also shown.

Similarly to as described with the cutting guides above, with the flying-geese cutting guide 700 a first fabric seam is placed proximal to and/or in engagement with the first seam engagement structure 722 and second fabric seam is placed proximal to and/or in engagement with the second seam engagement structure 772. The edges of the base 710 may then be used as cutting edges to cut the positioned fabric into the shape described by one or more edges of the base 710.

The base first side length 702 may preferably be about four inches in length, but may vary from a minimal typical length of about three inches to a maximal typical length of about six and a half inches, although there are no set minimal or maximal length limits. The length may also be incremented between about one inch and about 12 inches in increments of about one half inch, although increments and sizing may vary.

The base second side length 704 may preferably be about three inches in length, but may vary from a minimal typical length of about two inches to a maximal typical length of about four inches, although there are no set minimal or maximal length limits. The length may also be incremented between about two inches and about 12 inches in increments of about one half inch, although increments and sizing may vary.

The fabric engagement structure's width 725 may preferably be about three quarters of an inch, but may range from any length above zero to occupying the entire triangular section of the bottom of the base behind the first and second seam engagement structures 722, 772.

The tip offset 782 may preferably be one quarter of an inch, but may vary in size from about zero to two inches by increments of about an eighth of an inch.

FIG. 8 illustrates an interchangeable handle 800 that may be employed with any of the cutting guides discussed herein. The handle 800 includes a handle shaft 850, a handle grip element 860, and a handle thread element 878. Additionally shown are the handle grip element width 862, the handle grip element height 864, the handle shaft length 852. The handle thread element 878 further includes the handle shaft width 854, and the handle thread length 872.

As described above, the handle 800 may be interchangeably and repeatedly attached and removed from any of the cutting guides described above by threading the handle thread element 878 into the handle socket of the cutting guide, such as the handle socket 130 shown in FIG. 1. Consequently, a user may save money by only having to purchase one handle and/or may save storage space because cutting guides may be stored flat with the handle removed.

Additionally, an array of handles in different shapes may be offered for purchase by the consumer. The consumer may then choose the handle shape that they prefer and may transfer the preferred handle from one cutting guide to another in order to increase the user's comfort. Additionally, a user may prefer to use handles having different dimensions depending on the cutting guide being used.

The handle grip element width 862 may preferably be about two inches, but alternative embodiments may include any width greater than zero and there is no upper limit on the width. In other alternatives, the width may vary from about one eighth of an inch to four inches in increments of about one eighth of an inch.

The handle grip element height 864 may preferably be about three quarters of an inch, but alternative embodiments may include any height greater than zero and there is no upper limit on the height. In other alternatives, the height may vary from about one eighth of an inch to two inches in increments of about one eighth of an inch.

The handle shaft length 852 may preferably be about six inches, but alternative embodiments may include any length greater than zero and there is no upper limit on the length. In other alternatives, the length may vary from about one inch to about 10 inches in increments of about one half of an inch.

In one embodiment, the handle shaft length 852 is chosen so that when a user is grasping the handle grip element and using the cutting guide, the user's hands and/or fingers are not in the proximity of the cutting edges of the cutting guide. Thus, while the user is engaging the cutting edges with a cutting tool to cut the fabric positioned under the cutting guide, the user's hand and/or fingers may be located at a safe distance to prevent inadvertent harm. In this regard, in one embodiment, the user's cutting tool may be a razor cutter blade that is induced along the cutting guide edge. However, the handle shaft length may be six inches, more than sufficient for a user's hand and/or fingers that are grasping the handle grip element to be removed from the proximity of the razor cutter blade.

The handle shaft width 854 may preferably be about one half of an inch. but the dimension may vary as long as the handle shaft matches the handle socket on the base of the cutting guides. For example, the handle shaft width may vary from any width greater than zero to about one inch in increments of about one eighth of an inch.

The handle thread length 872 may preferably be the length of the thickness of the base of a cutting guide. In one embodiment, the handle thread length 872 is one half inch, but the length may vary from any length greater than zero to one inch in increments of one sixteenth of an inch. Additionally, in one embodiment, the handle thread length 872 is less than the thickness of the base so that the bottom edge of the handle thread is contained in the base.

Additionally, although the discussion above focuses on a threaded connection to thread the handle into the cutting guide or to thread the cutting guide into the handle, an alternative handle connecting system may be employed. For example, the handle may be attached to the base using a spring-biased locking system, such as a locking pin protruding from the shaft of the handle that may engage with a receiver on the base when the shaft of the handle is introduced into the handle socket. The locking pin may then be manually pressed to disengage the shaft of the handle from the base when desired.

Alternatively, the handle may be equipped with one or more lateral protrusions on its lower portion and the socket may include a groove for receiving the lateral protrusions. In this fashion, the handle may be introduced downwardly into the socket so that the handle's protrusions enter the socket's groove. The handle may then be twisted relative to the socket so that the handle protrusions enter a horizontal region of the groove so as to lock the handle to the socket.

Alternatively, the handle may be equipped with a pin or other structure on the lowest extremity of its base that mates vertically with a receiving structure in the socket when the handle is introduced into the socket in the base. The pin and receiving structure may be shaped to prevent rotational movement once the handle is introduced into the socket.

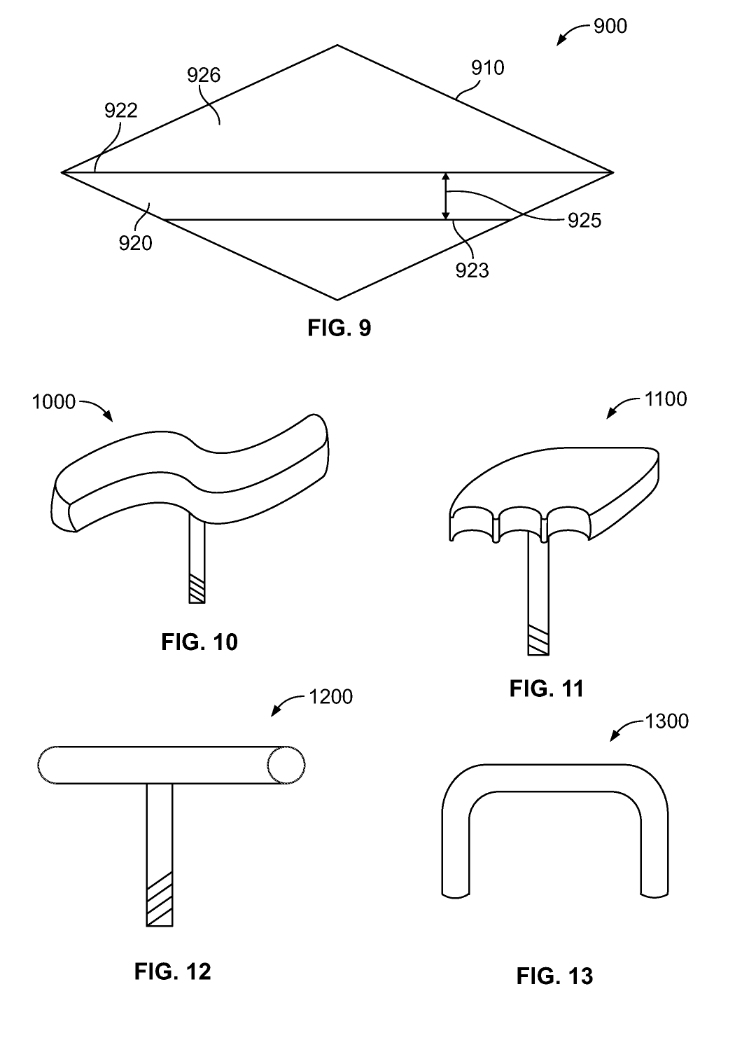

FIG. 9 illustrates a diamond-shape half-square cutting guide 900. The diamond-shape half-square cutting guide 900 is similar to the half-square cutting guide 100 of FIGS. 1-5, but is diamond shaped rather than square shaped. The diamond-shape half-square cutting guide 900 may thus be used for cutting fabric into diamond-shaped pieces rather than square pieces as with the half-square cutting guide 100 of FIGS. 1-5.

FIG. 9 shows the bottom view of the base 910 of the diamond-shape half-square cutting guide 900, similar to how FIG. 4 above illustrates the bottom view of the half-square cutting guide. The top view and side view of the diamond-shape half-square cutting guide, and the structures shown therein, are generally similar to those shown above for the half-square cutting guide in FIGS. 3 and 5, except the base of the diamond-shape half-square cutting guide is generally diamond-shaped.

As shown in FIG. 9, the diamond-shape half-square cutting guide 900 includes a base 910 having a fabric engagement structure 920, a seam engagement structure 922, the fabric height relief region 926, and a fabric engagement structure back edge 923. The fabric engagement structure width 925 is also indicated and represents the width between the seam engagement structure 922 and the fabric engagement structure back edge 923. As mentioned above, the fabric engagement structure width 925 may preferably be three-quarters of an inch, but may vary from any width greater than zero to occupying the entire half of the bottom of the base. The aspects and alternatives discussed above with regard to other embodiments of the cutting guide also apply to the diamond-shape half-square cutting guide 900.

Additionally, although FIG. 8 illustrated a handle grip element 860 shaped like a cylinder having rounded top and bottom edges, handle grip elements having different shapes may alternatively be employed.

FIG. 10 illustrates an alternative handle grip element having an “S” shape 1000. The “S” shape may be of rectangular, square, trapezoidal, circular, or ellipsoid cross section. The “S” shape handle grip element may be easier for a user to grasp and/or allow a user more control in maintaining the positioning of the cutting guide than the handle grip element 860 of FIG. 8.

FIG. 11 illustrates an alternative handle grip element having finger shaping 1100. The finger shaping may include one to four finger indentations and may also include a thumb engagement structure on another side of the handle. Additionally, the finger shaping may appear on one to four sides of the handle grip element. The handle grip element with finger shaping may be easier for a user to grasp and/or allow a user more control in maintaining the positioning of the cutting guide than the handle grip element 860 of FIG. 8.

FIG. 12 illustrates an alternative handle grip element having a “T” shape 1200. The top cross bar of the “T” shape may be of rectangular, square, trapezoidal, circular, or ellipsoid cross section. The “T” shape handle grip element may be easier for a user to grasp and/or allow a user more control in maintaining the positioning of the cutting guide than the handle grip element 860 of FIG. 8.

FIG. 13 illustrates an alternative handle grip element having an “U” shape 1300 with two connection points. The top cross bar and/or sides of the “U” shape may be of rectangular, square, trapezoidal, circular, or ellipsoid cross section. The “U” shape handle grip element may be easier for a user to grasp and/or allow a user more control in maintaining the positioning of the cutting guide than the handle grip element 860 of FIG. 8.

Additionally, the “U” shape handle grip element engages into the base at two locations, thus providing increased stability of the “U” shape handle grip element relative to the base. Alternatively, other handle grip elements having multiple connection points with the base may be employed, such as a tripod handle grip element or a double-“U” shape handle grip element representing two “U” shape handle grip elements that are attached at the centers of their top crossbar and positioned at an angle relative to each other. The double-“U” shape handle grip element thus attaches to the base at four locations.

Additionally, the handle grip element may be composed at least in part of any of the following, or may be composed of more than one of the following in combination: hard plastic, malleable plastic, rubber, neoprene, wood, or any other rigid material.

As recited above, one or more embodiments of the present invention provide a novel cutting guide, preferably for use in cutting fabric for quilting. More specifically, the cutting guides include a fabric engagement structure having one or more seam engagement structures for assisting in the positioning of the cutting guide. Additionally, the base includes a fabric relief area to accommodate the differing heights of the fabric on one side of the seam as opposed to the other, thus providing a firmer fit and less slippage. Once the cutting guide is firmly married to or engaged with the seam of a fabric to be cut, the user may simply advance a cutting device, such as a cutting wheel or blade along the cutting guide edge on the perimeter of the base. The resulting shapes are highly accurate, repeatable, and uniform and thus very useful for quilting.

Additionally, the cutting guides are equipped with a removable handle. The removable handle allows the cutting guides to be stored flatter, thus taking up less space. Additionally, the removable handles are interchangeable between cutting guides. Consequently, a user may select a handle that they prefer from a number of available handles and then use their preferred handle on many different cutting guides. For example, users may prefer handles of different sizes and/or shapes due to their physical attributes or what is most comfortable for them to grip.

Consequently, one or more embodiments of the present invention provide a quilt block cutting system that allows for increased comfort of the user, convenient storage, and uniform, repeatable sizing of desired block shapes, all of which may be highly desirable to quilters and other users. Additionally, the removable handle may have a handle length sufficient to elevate a user's fingers and/or hands away from the cutting edges when in use so as to reduce the likelihood that a user may accidentally cut themselves when using the cutting guide.

Additionally, although the discussion above may have referred to a single seam, a fabric piece having multiple seams may also be used in the cutting guide. Similarly, although the discussion above may have referred to a seam engagement surface in the singular, there cutting guide may include multiple seam engagement surfaces. For example, a linear seam engagement surface may include multiple seam engagement elements. Alternatively, the seam engagement surface may include a plurality of seam engagement angles. Additionally, multiple seam engagement surfaces may be present, such as in the flying-geese cutting guide.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A cutting guide including:
a base, wherein said base includes:
at least one cutting guide edge positioned along the perimeter of said base; and
a fabric engagement structure positioned on a bottom surface of said base and extending outwardly from said base,
wherein said fabric engagement structure includes a seam engagement surface,
wherein a fabric piece including a seam is positionable relative to said cutting guide edge by positioning said seam proximate to said seam engagement surface,
wherein, when said seam is positioned proximate to said seam engagement surface, said cutting guide edge describes a desired shape of a cut to be made in said fabric piece.

2. The cutting guide of claim 1 wherein said fabric engagement structure also includes a fabric holding surface,
wherein, when said fabric piece is positioned on a support surface and said seam is positioned proximate to said seam engagement surface, said fabric piece is compressed between said support surface and said fabric holding surface.

3. The cutting guide of claim 1 wherein said base also includes a fabric height relief region, wherein at least a portion of said fabric piece is thicker on one side of said seam than on the other and the thicker side of said fabric piece is positionable in said fabric height relief region.

4. The cutting guide of claim 1 wherein said seam engages with said seam engagement surface.

5. The cutting guide of claim 1 further including a handle attached to said base.

6. The cutting guide of claim 5 wherein said handle is removable and reattachable to said base.

7. The cutting guide of claim 6 wherein said handle includes a handle shaft having a threaded handle end and said base includes a threaded handle socket for receiving said threaded handle end.

8. A method of cutting a fabric piece having a seam into a desired shape, said method including:
positioning the fabric piece on a supporting surface;
positioning the seam of said fabric piece proximate to a seam engagement surface of a fabric engagement structure positioned on the bottom of a base of a cutting guide,
wherein said base includes at least one cutting guide edge positioned along the perimeter of said base, wherein said cutting guide edge describes a desired orientation of a cut to be made in said fabric piece; and
cutting said fabric piece along said cutting guide edge.

9. The method of claim 8, wherein said fabric engagement structure includes a fabric holding surface.

10. The method of claim 9 further including compressing said fabric piece between said supporting surface and said fabric holding surface.

11. The method of claim 8 wherein said base also includes a fabric height relief region and wherein at least a portion of said fabric piece is thicker on one side of said seam than on the other.

12. The method of claim 10 further including positioning said at least a portion of thicker side of said fabric piece in said fabric height relief region.

13. The method of claim 8 further including engaging said seam with said seam engagement surface.

14. The method of claim 8 further including positioning said base using a handle attached to said base.

15. The method of claim 14 further including removing and reattaching said handle to said base.

16. The method of claim 15 further including attaching said handle to said base by threading a threaded end of said handle into a threaded handle docket in said base.

17. A cutting guide system with an interchangeable handle, said system including:
a first cutting guide including a first base, wherein said first base includes
at least one first cutting guide edge positioned along the perimeter of said first base; and
a first fabric engagement structure positioned on the bottom surface of said first base and extending outwardly from said first base,
wherein said first fabric engagement structure includes a first seam engagement surface,
wherein a fabric piece including a seam is positionable relative to said first cutting guide edge by positioning said seam proximate to said first seam engagement surface,
wherein, when said seam is positioned proximate to said first seam engagement surface, said first cutting guide edge describes a first desired shape of a cut to be made in said fabric piece,
wherein said first base includes a first handle connecting system for connecting a handle to said first base;
a second cutting guide including a second base, wherein said second base includes
at least one second cutting guide edge positioned along the perimeter of said second base; and
a second fabric engagement structure positioned on the bottom surface of said second base and extending outwardly from said second base,
wherein said second fabric engagement structure includes a second seam engagement surface,
wherein a fabric piece including a seam is positionable relative to said second cutting guide edge by positioning said seam proximate to said second seam engagement surface,
wherein, when said seam is positioned proximate to said second seam engagement surface, said second cutting guide edge describes a second desired shape of a cut to be made in said fabric piece,
wherein said first desired shape is different from said second desired shape;
wherein said second base includes a second handle connecting system for connecting said handle to said second base; and
a first handle, wherein said handle is attachable to and removable from either of said first base using said first handle socket and said second base using said second handle socket.

18. The system of claim 17 wherein both said first handle socket and said second handle socket are threaded.

19. The system of claim 18 wherein said handle includes a handle shaft having a threaded end that may be threaded into said first handle socket and said second handle socket.

20. The system of claim 17 further including a second handle different from said first handle,
wherein said second handle may be attached and removed from both said first base using said first handle socket and said second base using said second handle socket.
